(19) United States
(12) Patent Application Publication
(10) Pub. No.: US 2011/0242054 A1
(43) Pub. Date: Oct. 6, 2011

(54) PROJECTION SYSTEM WITH TOUCH-SENSITIVE PROJECTION IMAGE

(75) Inventor: Fu-Kuan Tsu, Taipei (TW)

(73) Assignee: COMPAL COMMUNICATION, INC., Taipei (TW)

(21) Appl. No.: 13/052,984

(22) Filed: Mar. 21, 2011

(30) Foreign Application Priority Data
Apr. 1, 2010 (TW) 099110225

(51) Int. Cl. G06F 3/042

(52) U.S. Cl. 345/175

(57) ABSTRACT

A projection system includes an image projector, an invisible light transmitter and an invisible light sensor. The image projector is used for projecting a projection image on a physical plane. The invisible light transmitter is used for generating an invisible light plane, which is parallel with the physical plane. The invisible light sensor is in communication with the image projector. When a pointing object is placed on a touching point, an invisible light beam reflected from the pointing object is received by the invisible light sensor. According to the invisible light beam, a sensing signal indicative of a spatial coordinate position of the touching point is acquired and transmitted to the image projector. The image projector recognizes and calculates the spatial coordinate position of the touching point according to the sensing signal and performs a controlling action according to the spatial coordinate position.

### CLAIM OF PRIORITY

This application claims priority to Taiwanese Patent Application No. 099110225 filed on Apr. 1, 2010.

### FIELD OF THE INVENTION

The present invention relates to a projection system, and more particularly to a projection system with a touch-sensitive projection image.

### BACKGROUND OF THE INVENTION

With increasing development of the information generation, the projection system with the portable and easy-to-use benefits is widely used in conference, office, school and home. For most attendants in meetings or most businessmen, the projection system is usually used to make a presentation, hold a meeting or give a lecture.

The conventional projection system is usually operated with an image signal source (e.g. a portable computer or a portable communication device). The image outputted from the image signal source is projected onto a projection screen through the projection system. For controlling the projection image on the projection screen, a mouse, a keyboard or a touch panel of the image signal source is used. During the process of making a presentation, the user should repeatedly move to the position beside the image signal source to operate the mouse, the keyboard or the touch panel. This method of controlling the projection image is not user-friendly.

For solving the above drawbacks, a projection system with a touch-sensitive projection image has been disclosed. In such a projection system, the touch-sensitive projection image is projected onto a projection screen to achieve an interactive purpose. Generally, a laser pen or a finger reflector with an auxiliary light source is used to generate a pointing light beam. The pointing light beam is projected onto the projection image. By detecting the change of the pointing light beam on the projection image, the spatial coordinate position of the light source is realized. According to the spatial coordinate position, the projection image on the projection screen is controlled. Since the auxiliary light source is additionally held by the user's hand, the conventional method of controlling the projection image is inconvenient.

Moreover, the conventional method of controlling the projection image still has some other drawbacks. For example, since the brightness and/or the color of the projection image and the background color of the projection screen may adversely affect the accuracy of detecting the change of the pointing light beam, the calculating complexity is very high and the calculating accuracy is low. In such way, the interactive speed of controlling the projection image is usually unsatisfied.

### SUMMARY OF THE INVENTION

The present invention provides a projection system with a touch-sensitive projection image. By placing one or more fingers on the projection image, a desired controlling action is performed in an intuitive, convenient and user-friendly manner. In such way, the problem of using the auxiliary light source in the conventional projection system will be avoided.

The present invention also provides a projection system with a touch-sensitive projection image in order to simplify the calculating complexity, enhance the calculating accuracy and increase the interactive speed.

In accordance with an aspect of the present invention, there is provided a projection system. The projection system includes an image projector, an invisible light transmitter and an invisible light sensor. The image projector is used for projecting a projection image on a physical plane. The invisible light transmitter is used for generating an invisible light plane, which is parallel with the physical plane. An overlapped region between the invisible light plane and the projection image is defined as a touch-sensitive zone. The invisible light sensor is in communication with the image projector. When a pointing object is placed on a touching point of the touch-sensitive zone, an invisible light beam reflected from the pointing object is received by the invisible light sensor. According to the invisible light beam, a sensing signal indicative of a spatial coordinate position of the touching point is acquired and transmitted to the image projector. The image projector recognizes and calculates the spatial coordinate position of the touching point according to the sensing signal and performs a controlling action according to the spatial coordinate position.

In accordance with another aspect of the present invention, there is provided a projection system. The projection system includes an image projector, an invisible light transmitter and an invisible light sensor. The image projector is used for projecting a projection image on a physical plane. The invisible light transmitter is disposed beside the physical plane for generating an invisible light plane, which is parallel with the physical plane. When a pointing object is placed on a touching point of the invisible light plane, an invisible light beam reflected from the pointing object is received by the invisible light sensor. According to the invisible light beam, a sensing signal indicative of a spatial coordinate position of the touching point is acquired and transmitted to the image projector. The image projector recognizes and calculates the spatial coordinate position of the touching point according to the sensing signal and performs a controlling action according to the spatial coordinate position.

The above contents of the present invention will become more readily apparent to those ordinarily skilled in the art after reviewing the following detailed description and accompanying drawings, in which:

### BRIEF DESCRIPTION OF THE DRAWINGS

FIG. 1A is a schematic perspective view illustrating a projection system with a touch-sensitive projection image according to an embodiment of the present invention;

FIG. 1B is a schematic side view illustrating the projection system of FIG. 1A;

FIG. 2A is a schematic perspective view illustrating a projection system with a touch-sensitive projection image according to another embodiment of the present invention;

FIG. 2B is a schematic side view illustrating the projection system of FIG. 2A;

FIG. 3 is a schematic circuit block diagram illustrating the projection system of FIG. 1;

FIG. 4 schematically illustrates an invisible light sensor used in the projection system of the present invention;

FIG. 5 schematically illustrates an invisible light transmitter used in the projection system of the present invention;

FIG. 6 is a schematic circuit block diagram illustrating the projection system of FIG. 2; and

FIG. 7 is a schematic circuit block diagram illustrating a projection system with a touch-sensitive projection image according to another embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

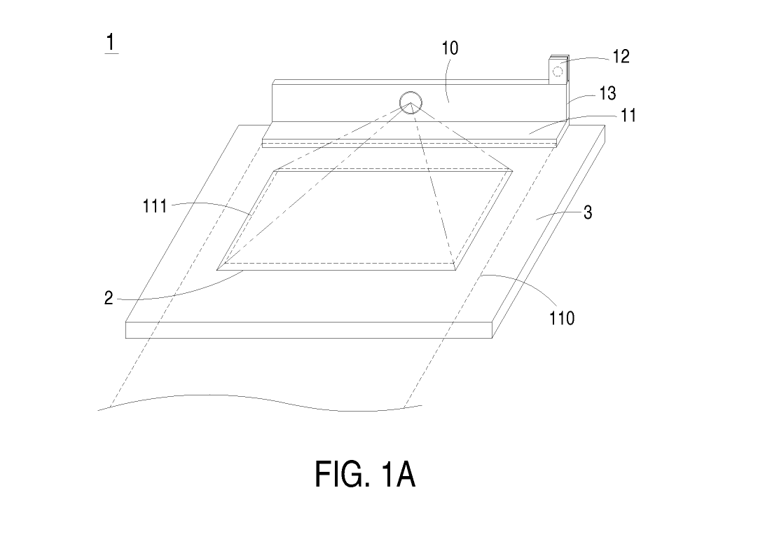

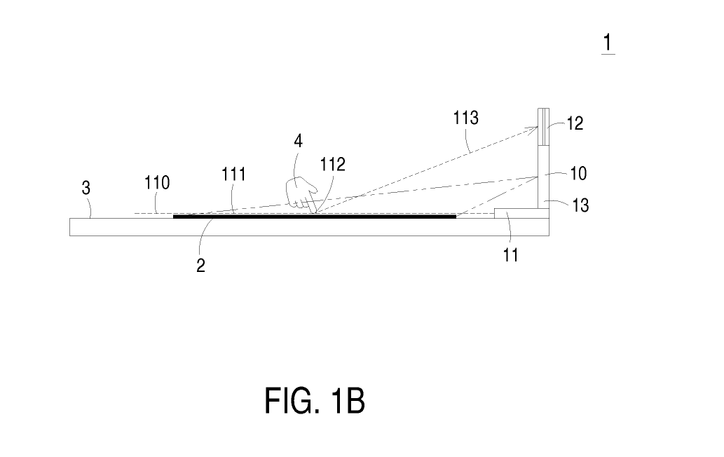

FIG. 1A is a schematic perspective view illustrating a projection system with a touch-sensitive projection image according to an embodiment of the present invention. FIG. 1B is a schematic side view illustrating the projection system of FIG. 1A. Please refer to FIGS. 1A and 1B. The projection system 1 comprises an image projector 10, an invisible light transmitter 11 and an invisible light sensor 12. The image projector 10 is used to project a projection image 2 on a physical plane 3. The projection image 2 is a visible light image. In addition, the projection image 2 comprises an input zone or an input mark (not shown). The invisible light transmitter 11 is arranged beside the physical plane 3 for generating an invisible light plane 110 (e.g. an infrared light plane), which is parallel with the physical plane 3. The invisible light plane 110 is expanded to at least partially cover the physical plane 3. Consequently, the invisible light plane 110 and the projection image 2 define touch-sensitive zone 111. Since the touch-sensitive zone 111 is an overlapped region between the invisible light plane 110 and the projection image 2, the touch-sensitive zone 111 is disposed over the physical plane 3. The invisible light sensor 12 is in communication with the image projector 10. In a case that a pointing object 4 (e.g. a finger of a user) is placed on a touching point 112 of the touch-sensitive zone 111, the invisible light beams 113 reflected from the pointing object 4 may be received and sensed by the invisible light sensor 12. According to the invisible light beams 113, a sensing signal indicative of the spatial coordinate position of the touching point 112 will be acquired. According to the sensing signal provided by the invisible light sensor 12, the image projector 10 can recognize and calculate the spatial coordinate position of the touching point 112. According to the processing and calculating result, the projection image 2 shown on the physical plane 3 is correspondingly controlled. For example, by placing one or more fingers on the touch-sensitive zone 111, it is possible to zoom in or zoom out the contents of the projection image, input data or commands, move the contents of the projection image, rotate the contents of the projection image or change the contents of the projection image.

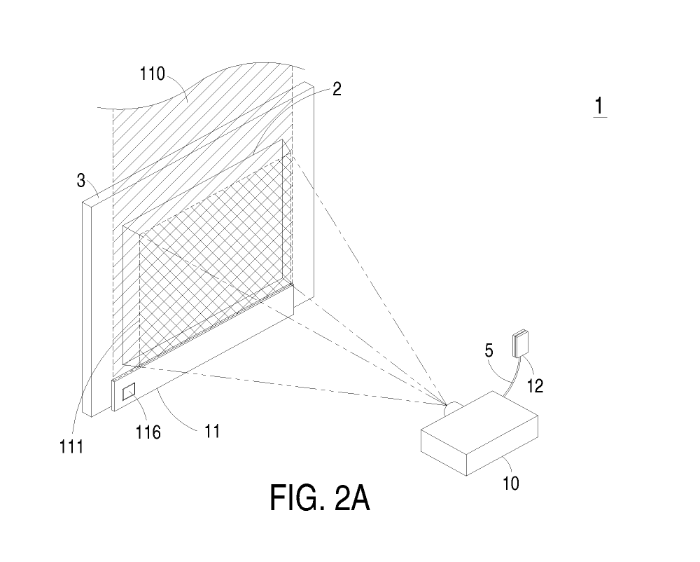

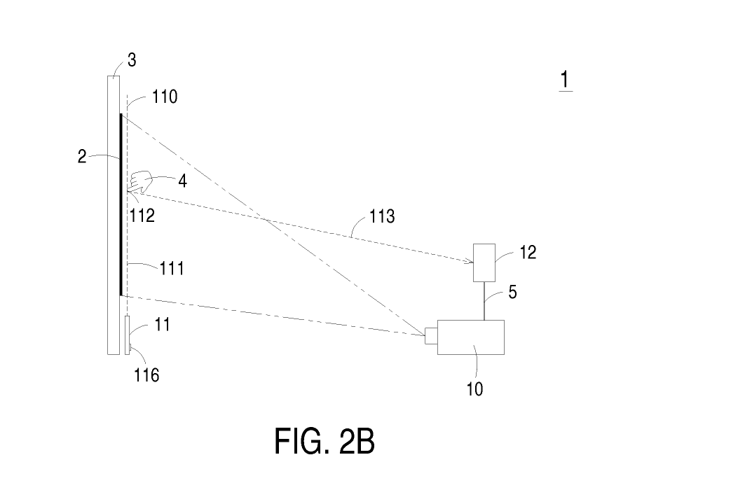

In this embodiment, the image projector 10, the invisible light transmitter 11 and an invisible light sensor 12 are combined together through a casing 13 to produce an integrated and portable projection system 1. Alternatively, as shown in FIGS. 2A and 2B, the image projector 10, the invisible light transmitter 11 and an invisible light sensor 12 of the projection system 1 are independent and separate components. As shown in FIGS. 2A and 2B, the image projector 10 and the invisible light sensor 12 are in communication with each other through a transmission wire 5. That is, the image projector 10 and the invisible light sensor 12 communicate with each other to exchange signals or data according to a wired transmission technology. Alternatively, the image projector 10 and the invisible light sensor 12 may utilize wireless communication modules (not shown) such as bluetooth modules to exchange signals or data according to a wireless transmission technology. In some embodiments, any two of the image projector 10, the invisible light transmitter 11 and an invisible light sensor 12 are combined together through a casing, but the remaining component is an independent component. An example of the physical plane 3 includes but is not limited to a wall surface, a projection screen, a desk surface or an electronic whiteboard.

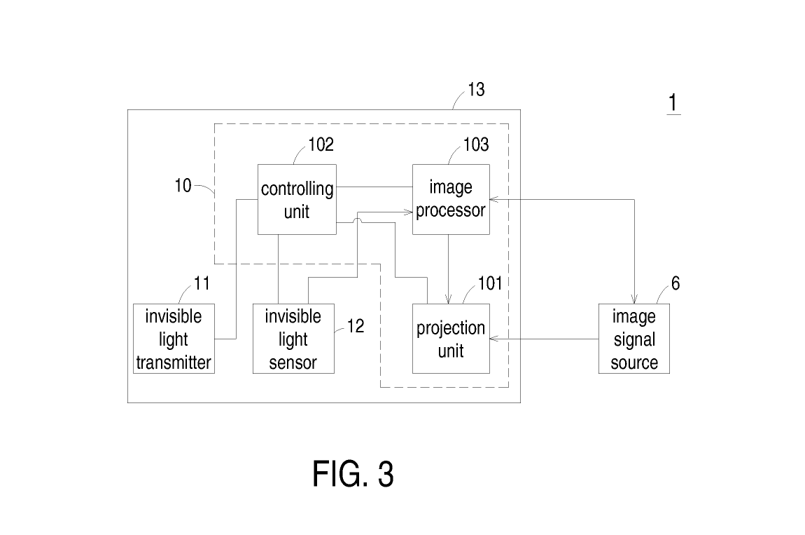

FIG. 3 is a schematic circuit block diagram illustrating the projection system of FIG. 1. Please refer to FIGS. 1A, 1B and 3. The image projector 10, the invisible light transmitter 11 and the invisible light sensor 12 are combined together through the casing 13 to produce an integrated and portable projection system 1. The image projector 10 comprises a projection unit 101, a controlling unit 102 and an image processor 103. By the projection unit 101, a projection image corresponding to an image signal provided by an image signal source 6 is projected on the physical plane 3. The image signal source 6 is swappable for a portable storage device of the image projector 10, a portable computer or a desktop computer. The invisible light transmitter 11 is connected with the controlling unit 102. Under control of the controlling unit 102, the invisible light transmitter 11 is selectively enabled to provide the invisible light plane 110 or disabled to stop generating the invisible light plane 110. In some embodiments, the invisible light transmitter 11 is not connected with the controlling unit 102, but the invisible light transmitter 11 is connected with a switch element (not shown). By adjusting the on/off states of the switch element, the invisible light transmitter 11 is selectively enabled to provide the invisible light plane 110 or disabled to stop generating the invisible light plane 110. Moreover, the invisible light sensor 12 is connected with the controlling unit 102 and the image processor 103. Under control of the controlling unit 102, a sensing signal is transmitted from the invisible light sensor 12 to the image processor 103. The image processor 103 is connected with the controlling unit 102, the invisible light sensor 12 and the image signal source 6. After sensing signal from the invisible light sensor 12 is recognized and processed by the image processor 103, the image processor 103 can recognize and calculate the spatial coordinate position of the touching point 112. The controlling unit 102 is connected with the invisible light transmitter 11, the invisible light sensor 12, the projection unit 101 and the image processor 103. The controlling unit 102 is used for controlling operations of the invisible light transmitter 11, the invisible light sensor 12, the projection unit 101 and the image processor 103. Moreover, according to the processing and calculating result of the image processor 103, associated actions of the projection image 2 on the physical plane 3 are controlled by the controlling unit 102. The actions of the projection image 2 include for example the action of zooming in/out the contents of the projection image, inputting data or commands, moving the contents of the projection image, rotating the contents of the projection image or changing the contents of the projection image.

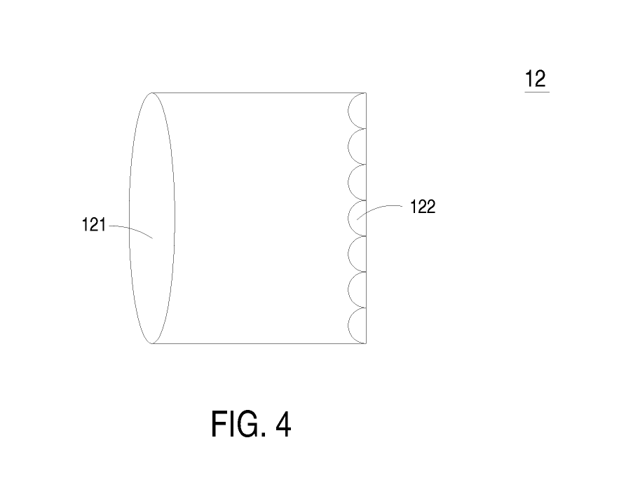

FIG. 4 schematically illustrates an invisible light sensor used in the projection system of the present invention. As shown in FIG. 4, the invisible light sensor 12 comprises a visible light filter 121 and an invisible light detecting element 122. The visible light filter 121 is used for blocking the visible light component of the incident light and allowing the invisible light component within a specified wavelength range to pass through. When the invisible light component passing through the visible light filter 121 is detected by the light detecting element 122, the light detecting element 122 generate a sensing signal indicative of the spatial coordinate position of the touching point 112. It is preferred that the invisible light transmitter 11 is an infrared light transmitter. An example of the invisible light sensor 12 includes but is not limited to an infrared sensor or an infrared camera.

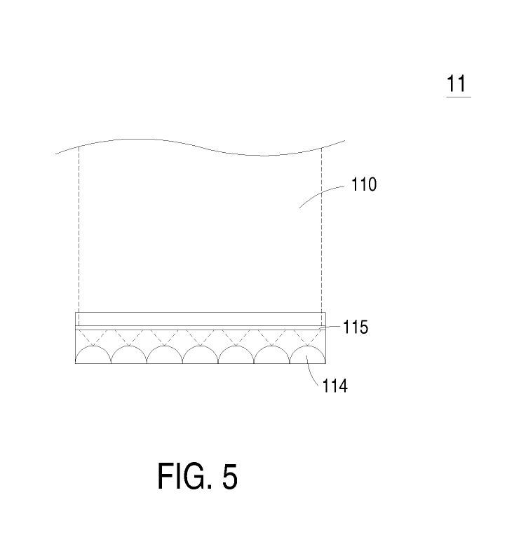

FIG. 5 schematically illustrates an invisible light transmitter used in the projection system of the present invention. As shown in FIG. 5, the invisible light transmitter 11 comprises one or more light sources 114 and one or more lenses 115. In an embodiment, the light sources 114 are light emitting diodes that emit invisible light. The lenses 115 are aligned with the light sources 114. By the lenses 115, the visible light beams emitted from the light sources 114 are shaped into the invisible light plane 110. Consequently, the invisible light plane 110 is parallel with the physical plane 3. It is preferred that the lenses 114 are cylindrical lenses.

In some embodiments, after the projection system is powered on and the touch-sensitive function of the projection image 2 is enabled, the image projector 10 may execute a step of calibrating the image signal and the sensing signal. In such way, the recognizing and calculating precision of the image processor 10 will be enhanced.

For operating the projection image 2 to perform a controlling operation (e.g. the action of changing a page, the action of zooming in/out the contents of the projection image or the action of moving the contents of the projection image), the user's finger is placed on the input zone or the input mark of the projection image 2 corresponding to a touching point 112 of the touch-sensitive zone 111 of the invisible light plane 110. Meanwhile, by the invisible light sensor 12, the invisible light beams 113 reflected from the touching point 112 is converted into a sensing signal indicative of the spatial coordinate position of the touching point 112 will be acquired. Under control of the controlling unit 102, the sensing signal is transmitted from the invisible light sensor 12 to the image processor 103 of the image projector 10. After the sensing signal is recognized and processed by the image processor 103 of the image projector 10, the spatial coordinate position of the touching point 112 is acquired. According to the processing and calculating result of the image processor 103, the projection image 2 shown on the physical plane 3 is correspondingly controlled by the controlling unit 102. For example, the action of changing a page, the action of zooming in/out the contents of the projection image or the action of moving the contents of the projection image is performed. Moreover, after the x-coordinate and y-coordinate of the spatial coordinate position of the touching point 112 are acquired, the controlling action can be performed. Since it is not necessary to judge the z-coordinate of the touching point 112, the calculating complexity is simplified, the calculating accuracy is enhanced, and the interactive speed is increased.

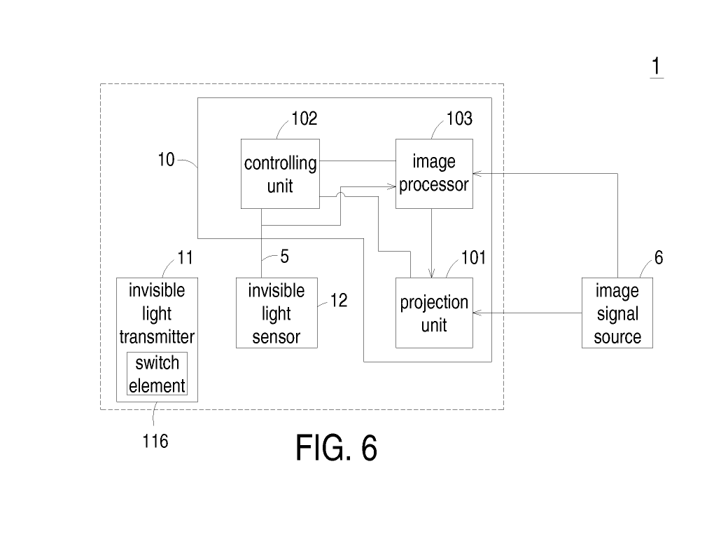

FIG. 6 is a schematic circuit block diagram illustrating the projection system of FIG. 2. Please refer to FIGS. 2A, 2B and 6. The image projector 10, the invisible light transmitter 11 and the invisible light sensor 12 are independent and separate components. The invisible light transmitter 11 comprises a switch element 116. By adjusting the on/off states of the switch element 116, the invisible light transmitter 11 is selectively enabled to provide the invisible light plane 110 or disabled to stop generating the invisible light plane 110. The invisible light sensor 12 is connected with the image projector 10 through a transmission wire 5. The operating principles and functions of the image projector 10, the invisible light transmitter 11 and the invisible light sensor 12 included in the projection system of FIG. 6 are similar to those of FIG. 3, and are not redundantly described herein.

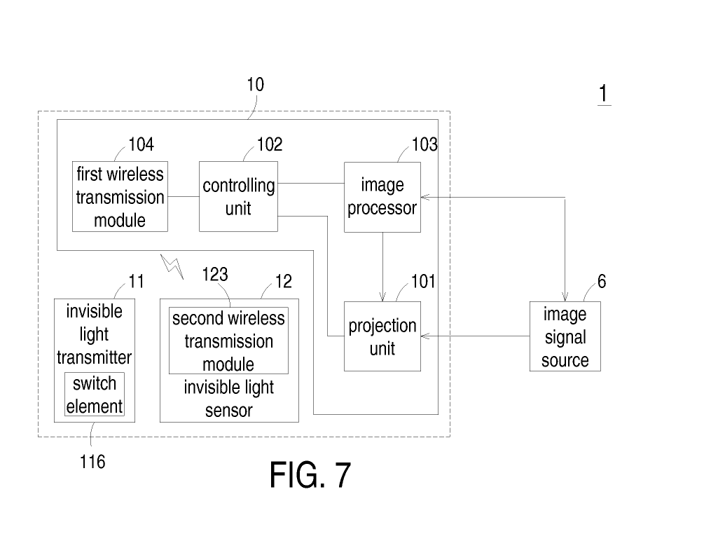

FIG. 7 is a schematic circuit block diagram illustrating a projection system with a touch-sensitive projection image according to another embodiment of the present invention. As shown in FIG. 7, the image projector 10, the invisible light transmitter 11 and the invisible light sensor 12 are independent and separate components. In this embodiment, the invisible light sensor 12 is in communication with the image projector 10 according to a wireless communication technology rather than the wired communication technology. The image projector 10 further comprises a first wireless communication module 104. The invisible light sensor 12 further comprises a second wireless communication module 123. The second wireless communication module 123 is in communication with the first wireless communication module 104 according to a wireless communication technology. That is, the invisible light sensor 12 and the image projector 10 can wirelessly communicate with each other to exchange signals or data through the first wireless communication module 104 and the second wireless communication module 123. The operating principles and functions of the image projector 10, the invisible light transmitter 11 and the invisible light sensor 12 included in the projection system of FIG. 7 are similar to those of FIG. 6, and are not redundantly described herein.

From the above description, the present invention provides a projection system with a touch-sensitive projection image. By placing one or more fingers on the projection image, a desired controlling action is performed in an intuitive, convenient and user-friendly manner. In such way, the problem of using the auxiliary light source in the conventional projection system will be avoided. Moreover, the projection system has simple architecture. Since the combination of the invisible transmitter and the invisible sensor is employed to judge the spatial coordinate position of the touching point, the adverse influences resulted from the visible light component of the projection image and the background color of the physical plane will be minimized. Under this circumstance, the calculating complexity is simplified, the calculating accuracy is enhanced, and the interactive speed is increased. Moreover, after the x-coordinate and y-coordinate of the spatial coordinate position of the touching point are acquired, the controlling action can be performed. Since it is not necessary to judge the z-coordinate of the touching point, the calculating simplification, the calculating accuracy and the interactive speed will be further increased.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A projection system, comprising:
an image projector for projecting a projection image on a physical plane;
an invisible light transmitter for generating an invisible light plane, which is parallel with said physical plane, wherein an overlapped region between said invisible light plane and said projection image is defined as a touch-sensitive zone; and
an invisible light sensor in communication with said image projector, wherein when a pointing object is placed on a touching point of said touch-sensitive zone, an invisible light beam reflected from said pointing object is received by said invisible light sensor, wherein according to said invisible light beam, a sensing signal indicative of a spatial coordinate position of said touching point is acquired and transmitted to said image projector, wherein said image projector recognizes and calculates said spatial coordinate position of said touching point according to said sensing signal and performs a controlling action according to said spatial coordinate position.

2. The projection system according to claim 1 wherein said invisible light transmitter is an infrared light transmitter, and said invisible light sensor is an infrared sensor or an infrared camera.

3. The projection system according to claim 1 wherein said invisible light transmitter comprises at least one light source and at least one lens, and said invisible light sensor comprises a visible light filter and an invisible light detecting element.

4. The projection system according to claim 1 wherein said image projector comprises:
a projection unit for projecting an image signal outputted from an image signal source, thereby creating said projection image on said physical plane;
an image processor for recognizing and processing said sensing signal from said invisible light sensor, thereby recognizing and calculating said spatial coordinate position of said touching point; and
a controlling unit connected with said projection unit and said image processor for controlling operations of said projection unit and said image processor and performing said controlling action according to said spatial coordinate position.

5. The projection system according to claim 4 wherein said invisible light sensor in communication with said controlling unit and said image processor of said image projector, wherein under control of said controlling unit, said sensing signal is transmitted from said invisible light sensor to said image processor.

6. The projection system according to claim 1 wherein said projection image has an input zone or an input mark corresponding to said touching point.

7. The projection system according to claim 1 wherein said projection system further comprises a casing, wherein at least two of said image projector, said invisible light transmitter and said invisible light sensor are combined together through said casing.

8. The projection system according to claim 1 wherein said image projector, said invisible light transmitter and said invisible light sensor are independent and separate components.

9. The projection system according to claim 1 wherein said controlling action includes an action of zooming in/out contents of said projection image, an action of inputting data or commands, an action of moving contents of said projection image, an action of rotating contents of said projection image or an action of changing contents of said projection image.

10. A projection system, comprising:
an image projector for projecting a projection image on a physical plane;
an invisible light transmitter disposed beside said physical plane for generating an invisible light plane, which is parallel with said physical plane; and
an invisible light sensor, wherein when a pointing object is placed on a touching point of said invisible light plane, an invisible light beam reflected from said pointing object is received by said invisible light sensor, wherein according to said invisible light beam, a sensing signal indicative of a spatial coordinate position of said touching point is acquired and transmitted to said image projector, wherein said image projector recognizes and calculates said spatial coordinate position of said touching point according to said sensing signal and performs a controlling action according to said spatial coordinate position.
